(19) United States
(12) Patent Application Publication
(10) Pub. No.: US 2019/0020184 A1
(43) Pub. Date: Jan. 17, 2019

(54) VAPOR HOOD

(71) Applicant: Gabe Coscarella, Edmonton (CA)

(72) Inventor: Gabe Coscarella, Edmonton (CA)

(21) Appl. No.: 16/037,968

(22) Filed: Jul. 17, 2018

(30) Foreign Application Priority Data
Jul. 17, 2017 (CA) 2973563

(51) Int. Cl. H02G 3/08; F21S 8/02; F21V 21/04

(52) U.S. Cl. CPC H02G 3/088; H02G 3/083; F21V 21/04; F21S 8/02

(57) ABSTRACT

A vapor hood for a component of a building is provided. The vapor hood has an enclosure with a sidewall, a rear wall, and a front edge opposite the rear wall. The sidewall and the rear wall define an inner cavity, and the enclosure is sized such that the sidewall surrounds the component when installed. The vapor hood has a skirt at the front edge of the enclosure that extends outward relative to the sidewall, the enclosure and the skirt being formed from waterproof, pliable material. The enclosure has a cable receiver spaced behind the front edge with an engagement surface that engages a cable received within the cable receiver. The cable receiver extends away from the rear wall or the sidewall of the enclosure.

### TECHNICAL FIELD

This relates to a vapor hood such as may be used in building construction.

### BACKGROUND

In the construction of buildings, vapour barriers are provided to seal between the exterior of the building and the interior. In various situations, it is required to pass building components through the vapour barrier. In order to maintain the building envelope, these penetrations through the vapour barrier are typically sealed around the component.

### SUMMARY

According to an aspect, there is provided a vapor hood for a component of a building, the component being connected to a cable, and the vapor hood comprising an enclosure having a sidewall, a rear wall, and a front edge opposite the rear wall. The sidewall and the rear wall define an inner cavity and are sized such that the sidewall surrounds the component when installed. A skirt at the front edge of the enclosure extends outward relative to the sidewall, where the enclosure and the skirt are formed from waterproof, pliable material. The enclosure comprises a cable receiver that is spaced behind the front edge, the cable receiver having an engagement surface that engages a cable when received within the cable receiver, the cable receiver extending away from the rear wall or the sidewall of the enclosure.

According to another aspect, the cable receiver may extend away from the rear wall.

According to another aspect, the engagement surface of the cable receiver may taper toward an end that is spaced from the rear wall or sidewall of the enclosure.

According to another aspect, the engagement surface may engage the cable with a friction fit.

According to another aspect, the cable receiver may comprise a closed end, the closed end being cuttable or frangible to allow passage of the cable.

According to another aspect, the vapor hood may further comprise a self-supporting mounting plate attached to the skirt adjacent to the front edge, the mounting plate having an opening that aligns with the enclosure.

According to an aspect, there is provided in combination a component of a building, a cable connected to the component, and a vapor hood for the component, the vapor hood comprising an enclosure having a sidewall, a rear wall, and a front edge opposite the rear wall, wherein the sidewall and the rear wall define an inner cavity and are sized such that the sidewall surrounds the component when installed, and a skirt at the front edge of the enclosure that extends outward relative to the sidewall, the enclosure and the skirt being formed from waterproof, pliable material, the enclosure comprising a cable receiver that is spaced behind the front edge, the cable receiver having an engagement surface that engages a cable when received within the cable receiver, the cable receiver extending away from the rear wall or the sidewall of the enclosure.

According to another aspect, the cable receiver may extend away from the rear wall.

According to another aspect, the engagement surface of the cable receiver may taper toward an end that is spaced from the rear wall or sidewall of the enclosure.

According to another aspect, the engagement surface may engage the cable with a friction fit.

According to another aspect, the cable receiver may be taped against the cable.

According to another aspect, the cable receiver may comprise a closed end, the closed end being cuttable or frangible to allow passage of the cable.

According to another aspect, the combination may further comprise a self-supporting mounting plate attached to the skirt adjacent to the front edge, the mounting plate having an opening that aligns with the enclosure such that the front edge of the enclosure encompasses the opening

According to an aspect, there is provided a method of installing a component, the method comprising the steps of attaching a self-supporting mounting plate and a vapor hood to a structural member of a building. The mounting plate has an opening, and the vapor hood comprises an enclosure having a sidewall, a rear wall, and a front edge opposite the rear wall. The sidewall and the rear wall define an inner cavity and the front edge encompasses the opening of the mounting plate, and a skirt at the front edge of the enclosure extends outward relative to the sidewall. The enclosure and the skirt are formed from waterproof, pliable material. The enclosure comprises a cable receiver that is spaced behind the front edge. The cable receiver extends away from the rear wall or from the sidewall of the enclosure, and a cable is passed through the cable receiver and into the enclosure. The cable receiver has an engagement surface that engages the cable. Drywall is mounted to the structural member of the building such that the drywall covers the enclosure. An opening is cut in the drywall that leads into the enclosure of the vapor hood, the component is connected to the cable, and the component is mounted into the opening in the drywall such that the sidewall of the vapor hood surrounds at least a portion of the component when installed.

According to another aspect, the mounting plate may comprise a cutout guide and cutting an opening in the drywall may comprise using the cutout guide to cut the opening.

According to another aspect, the cable receiver may extend away from the rear wall.

According to another aspect, the engagement surface of the cable receiver may taper toward an end that is spaced from the rear wall or sidewall of the enclosure.

According to another aspect, the engagement surface may engage the cable with a friction fit.

According to another aspect, passing the cable through the cable receiver may further comprise the step of taping the cable receiver against the cable.

According to another aspect, a closed end of the cable receiver may be opened to receive the cable.

According to an aspect, there is provided in combination a self-supporting mounting plate having an opening and a vapor hood for a component of a building, the vapor hood comprising an enclosure having a sidewall, a rear wall, and a front edge opposite the rear wall, the sidewall and the rear wall defining an inner cavity, the enclosure being sized such that the sidewall surrounds the component when installed, and the front edge of the enclosure encompassing the opening of the mounting plate, and a skirt at the front edge of the enclosure that extends outward relative to the sidewall, the enclosure and the skirt being formed from waterproof, pliable material, the enclosure comprising a cable receiver that is spaced behind the front edge, the cable receiver having an engagement surface that engages a cable when received within the cable receiver, the cable receiver extending away from the rear wall or the sidewall of the enclosure, wherein the skirt of the vapor hood comprises one or more apertures and the mounting plate is secured to the vapor hood by inserting at least a portion of the mounting plate through the one or more apertures.

According to another aspect, the cable receiver may extend away from the rear wall.

According to another aspect, the engagement surface of the cable receiver may taper toward an end that is spaced from the rear wall or sidewall of the enclosure.

According to another aspect, the engagement surface engages the cable with a friction fit.

According to another aspect, the cable receiver may be taped against the cable.

According to another aspect, a closed end of the cable receiver may be opened to receive the cable.

According to another aspect, the mounting plate may be rectangular, the skirt of the vapour hood may comprise four apertures corresponding to the corners of the mounting plate, and the corners of the mounting plate may be inserted through corresponding apertures.

According to another aspect, the enclosure and the skirt may be integrally formed from a single piece of waterproof, pliable material.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top perspective view of a vapor hood.

FIG. 2 is a bottom plan view of the vapor hood of FIG. 1.

FIG. 3 is a top plan view of an alternate vapor hood with a mounting plate.

FIG. 4 is a bottom plan view of the alternate vapor hood and mounting plate of FIG. 3.

FIG. 5 is a side elevation view of a vapor hood and mounting plate.

FIG. 6 is a side elevation view in partial cross-section of a vapor hood with a cable passing through a passage in the vapor hood.

FIG. 7a-7c are side elevation views in partial cross-section showing the installation of a light fixture using a vapor hood.

FIG. 8a-8f are side elevation views in cross-section of different cable receivers in a vapor hood.

### DETAILED DESCRIPTION

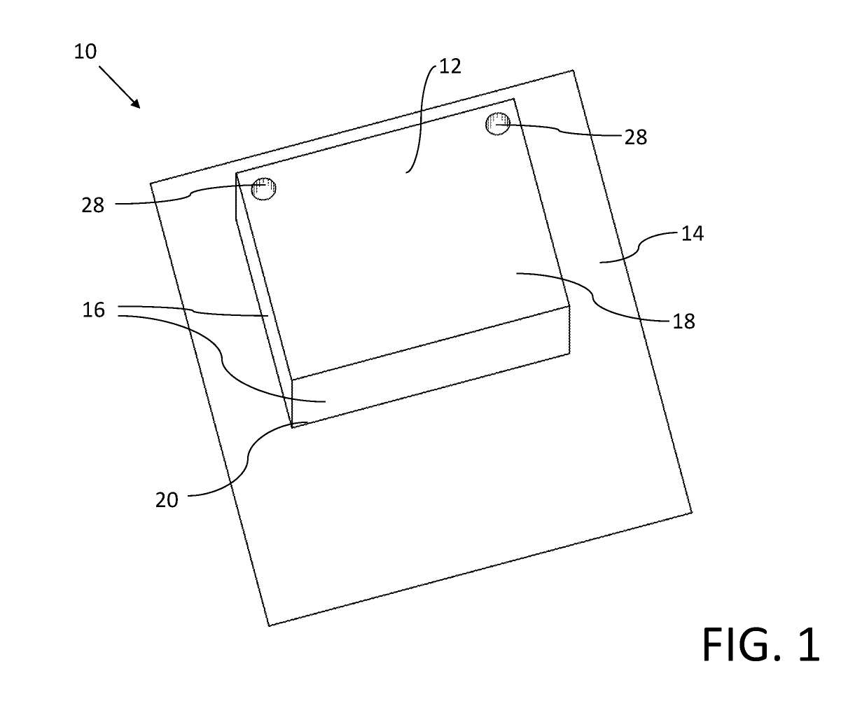

A vapor hood generally identified by reference numeral 10, will now be described with reference to FIG. 1 through 8. In the description below, vapor hood 10 is described in the context of a lighting fixture 24. However, it will be understood that the same principles are applicable to other electrical components, communication components, or other components 24 that are connected by a cable 26 when installed in a building.

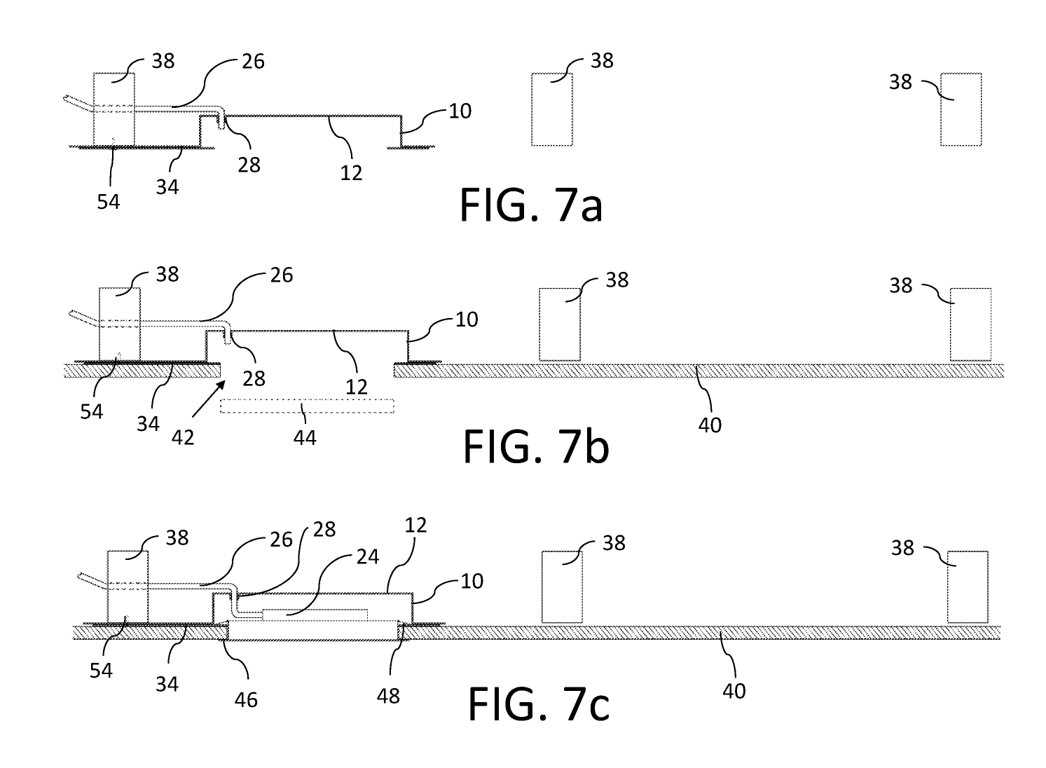

Referring to FIG. 1, vapor hood 10 has an enclosure 12 and a skirt 14. Referring to FIG. 6, enclosure 12 has a sidewall 16, a rear wall 18, and a front edge 20 opposite rear wall 18 that surrounds an opening that provides access to an inner cavity 22. This allows inner cavity 22 to be used as a pocket to receive a component, as a hood to cover a component, etc. Sidewall 16 and rear wall 18 are large enough to surround and overlie a component 24 when installed, as shown in FIG. 7c. This will depend on the size of component 24, and its orientation and position when installed, as will become apparent from the discussion below.

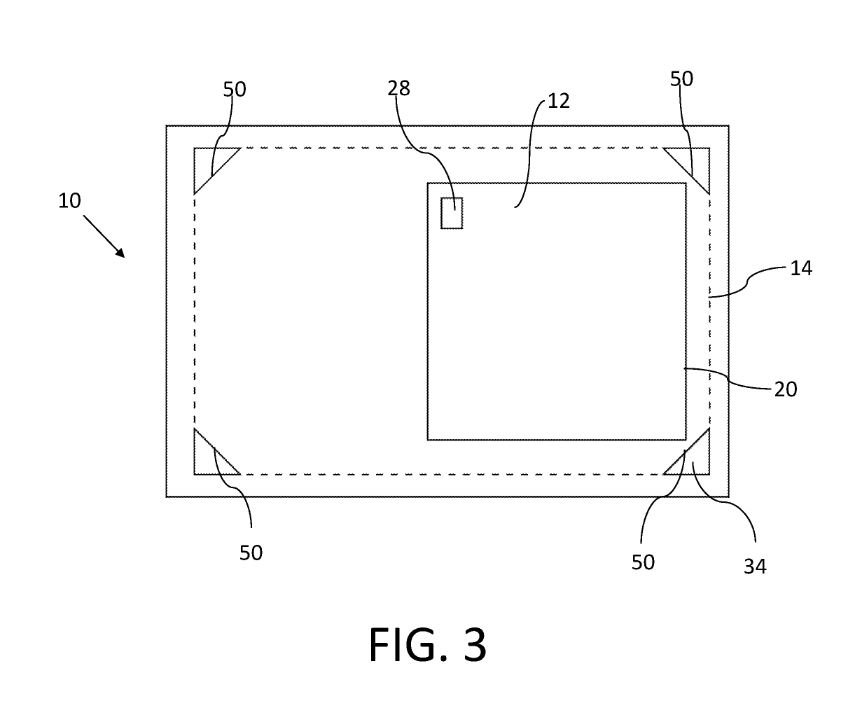

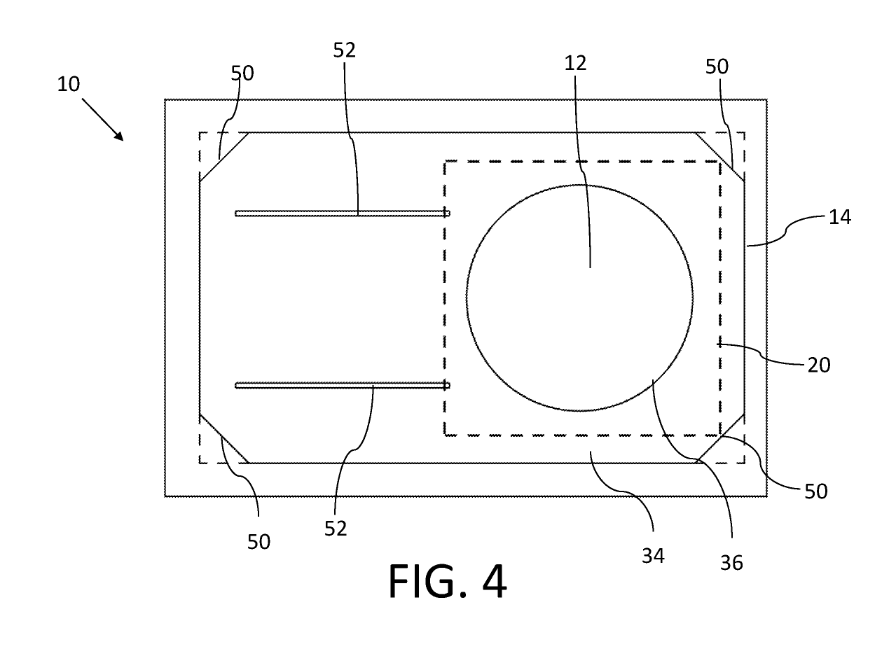

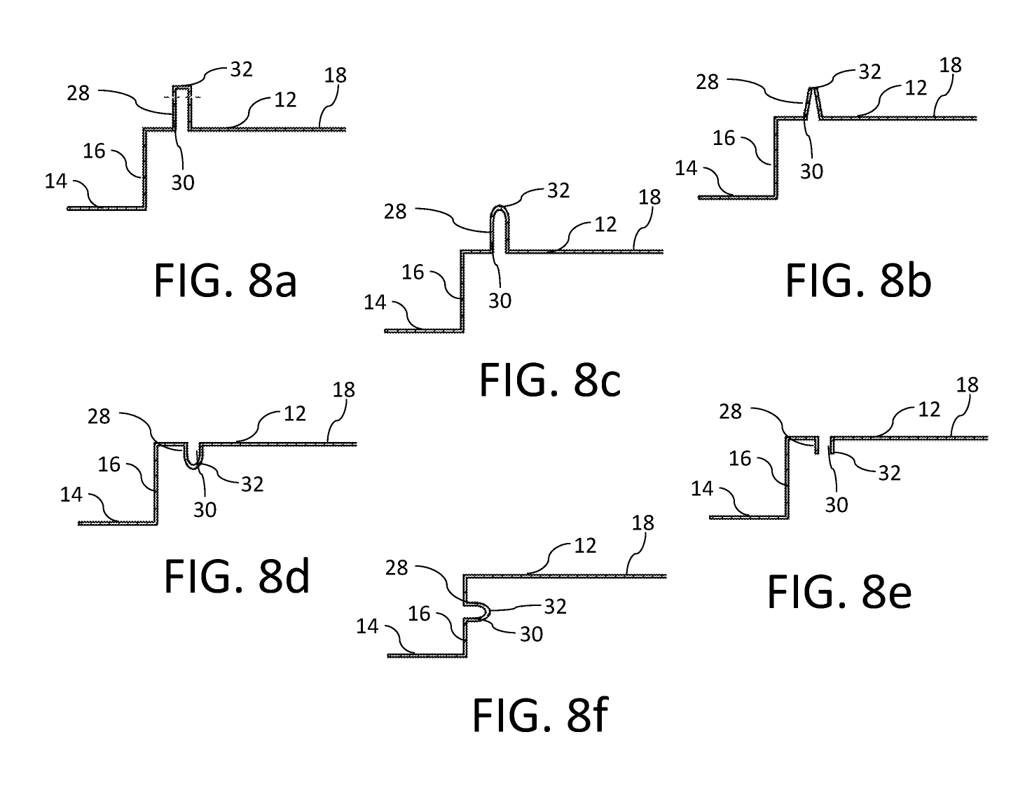

Referring to FIG. 1, skirt 14 is positioned at front edge 20 of enclosure 12 and extends outward relative to sidewall 16. Enclosure 12 and skirt 14 are preferably integrally formed from a single piece of waterproof, pliable material, but may be a two-part construction as will be understood. Enclosure 12 has a cable receiver 28 spaced behind front edge 20. Cable receiver 28 has an engagement surface 30 that engages a cable 26 when received within cable receiver 28, as shown in FIG. 6. Cable receiver 28 extends away from rear wall 18 or sidewall 16 of enclosure 12, as shown in FIG. 8a-8f. Referring to FIG. 3 and FIG. 4, vapor hood 10 may further comprise a self-supporting mounting plate 34 attached to skirt 14 adjacent to front edge 20, and mounting plate 34 may have an opening 36 that aligns with enclosure 12. Referring to FIG. 7c, vapor hood 10 is shown in combination with the building component 24 and mounting plate 34.

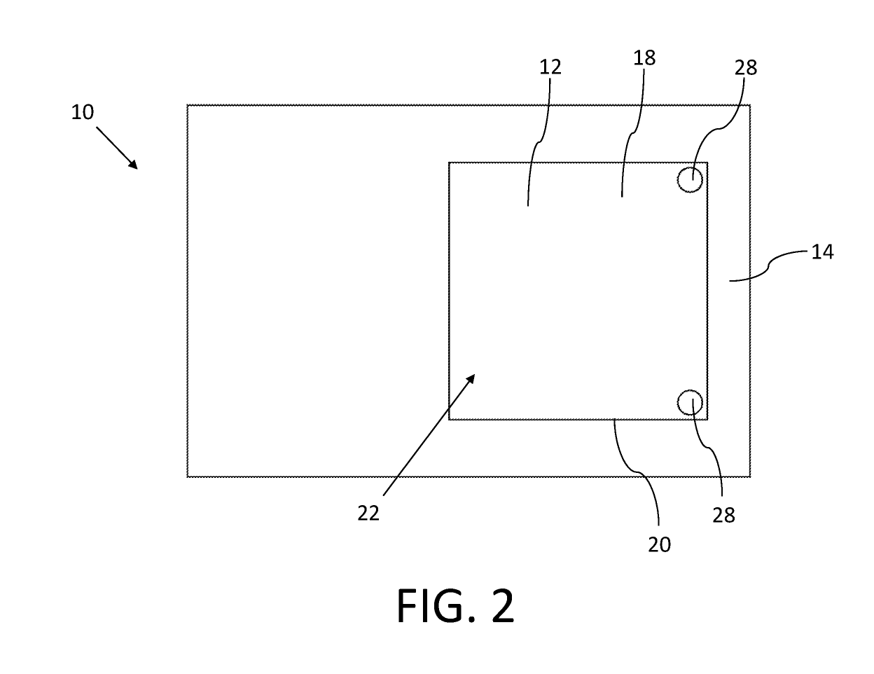

As can be seen in FIG. 8a-8f, cable receiver 28 may take a variety of shapes, and may extend either into or out of enclosure 12. It will be understood that these are merely some examples of possible configurations, and any of the shapes shown are equally applicable to the rear wall and the sidewall, as well as to extending into or out of enclosure 12. As shown in FIG. 8b, engagement surface 30 of cable receiver 28 may taper toward an end 32 that is spaced from rear wall 18 or sidewall 16 of enclosure 12. Where engagement surface 30 is tapered, or where the relative sizes of engagement surface 30 and cable 26 are sufficiently similar, engagement surface 30 may engage cable 26 with a friction fit, and depending on the material used may involve a plastic or elastic deformation of cable receiver 28. As shown, end 32 may either be open or closed prior to installation of cable 26. For example, as shown in FIG. 8a, end 32 of cable receiver 28 may be closed, and may be cuttable or frangible to allow passage of cable 26. For example, cable receiver 28 may be cut by an installer to the desired size or height during installation of enclosure 12. Alternatively, cable receiver 28 may be frangible, either by providing a weakened area or perforated line, or simply based on the material properties that allow a hole to be created when pressure is applied in a localized area, such that inserting cable 26 creates the necessary opening. Referring to FIG. 2 and FIG. 3, it will be understood that more than one cable receiver 28 may be provided to accommodate components 24 having more than one cable 26, to accommodate multiple components 24, or to allow the installer different options for the location of cable 26 relative to component 24. Cable receiver 28 may also have a variety of shapes depending on the type of cable 26 or other use or manufacturing considerations, such as the circular shape shown in FIG. 2 and the rectangular shape shown in FIG. 3.

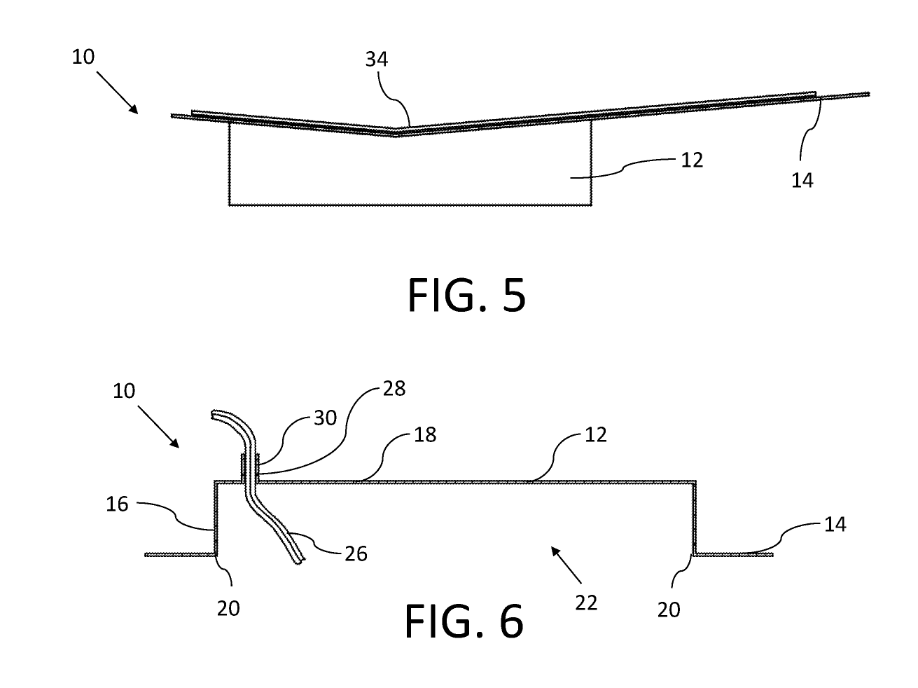

Referring to FIG. 3 and FIG. 4, a self-supporting mounting plate 34 may be attached to vapor hood 10. As shown, skirt 14 of vapor hood 10 has one or more apertures 50, and mounting plate 34 is secured to vapor hood 10 by inserting at least a portion of mounting plate 34 through the one or more apertures 50. In the depicted embodiment, mounting plate 34 is rectangular, and skirt 14 has four apertures 50, one located near each corner and corresponding to the corners of mounting plate 34, with the corners of mounting plate 34 being inserted through the corresponding apertures 50. Referring to FIG. 5, mounting plate 34 may be provided with a bend, which will tend to cause vapor hood 10 to bend when mounting plate 34 and vapor hood 10 are attached together. This bend will tend to straighten when mounting plate 34 is resilient, such that mounting plate 34 and vapor hood 10 are straightened when installed. Mounting plate 34 may, for example, be a metal plate.

A method of installing a component 24 will now be described with reference to FIG. 7a through FIG. 7c. Mounting plate 34 and vapor hood 10 are attached to a structural member 38 of a building. Mounting plate 34, when used in this manner, is self-supporting and sufficiently strong to also support vapor hood 10, as shown in FIG. 7a. As shown, structural member 38 is a joist above a room, where drywall has not yet been installed. However, it will be understood that structural member 38 may be a stud in a wall, or other structural member 38 of a building in a variety of orientations. Mounting plate 34 can be attached to structural member 38 using a variety of techniques, for example, using mounting slots 52 (shown in FIG. 4) and fasteners 54 (shown in FIG. 7a). Slots 52 allow the position of mounting plate 34 to be adjusted relative to structural member 38 at the time of installation. Other mounting techniques known in the art may also be used. Cable 26 may pass through or around structural member 38, as required by the appropriate building code and the structure of the building, and is passed through cable receiver 28 of vapor hood 10 and into enclosure 12. Cable 26 may be passed through cable receiver 28 of vapor hood 10 as discussed above with reference to FIG. 8a through 8f. In particular, cable 26 may be secured by friction fit within cable receiver 28, or it may also be secured using other techniques, such as taping cable receiver 28 against cable 26 to secure them together and provide a seal.

Referring to FIG. 7b, Drywall 40 is mounted to structural member 38, using techniques as are known in the art. Drywall 40 covers enclosure 12 when installed. An opening 42 is cut in drywall 40 and a portion 44 of drywall 40 is removed as shown in FIG. 7b. Opening 42 is cut so that it permits access to enclosure 12 of vapor hood 10. Mounting plate 34 may have opening 36 sized such that it acts as a cutout guide to cut opening 42 in drywall 40 without damaging vapor hood 10. The cutout guide formed by opening 36 is used to cut the opening 44, and is preferably spaced inward from front edge 20 sufficiently that enclosure 12 cannot be cut while portion 44 is being separated from drywall 40. Component 24 can then be installed through opening 42 and connected to cable 26, as shown in FIG. 7c.

In the depicted embodiment component 24 is an LED pot light having a faceplate 46 and mounting brackets 48, and component 24 mounts against both drywall 40 and mounting plate 34. It will be understood that other components, such as electrical outlets, electrical switches, other types of electrical components, communications modules, etc. may be installed using a variety of mounting techniques, as known in the art. This will depend on the nature of component 24 and the location of installation, and may require some modification of enclosure 12 or mounting plate 34 to accommodate the component being installed. Vapor hood 10 surrounds at least a portion of component 24 when installed, and in particular, preferably surrounds the portion of component 24 that would otherwise be exposed to an airspace on the other side of structural member 38, such as the rear or back surface, and some or all of the sidewall of the component, such that vapor hood 10 is able to tie into the building envelope. As shown in FIG. 7c, the entire component 24 may be contained within enclosure 12. However, it will be understood that accessories such as faceplate 46 may be added that extend beyond sidewalls 16. Skirt 14 of vapor hood 10 may be tied into the vapor barrier surrounding structural member 38 (not shown), such as by taping skirt 14 and the vapor barrier material together, or through the application of adhesive between the two layers.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A vapor hood for a component of a building, the component being connected to a cable, the vapor hood comprising:
an enclosure having a sidewall, a rear wall, and a front edge opposite the rear wall, wherein the sidewall and the rear wall define an inner cavity and are sized such that the sidewall surrounds the component when installed; and
a skirt at the front edge of the enclosure that extends outward relative to the sidewall, the enclosure and the skirt being formed from waterproof, pliable material;
the enclosure comprising a cable receiver that is spaced behind the front edge, the cable receiver having an engagement surface that engages a cable when received within the cable receiver, the cable receiver extending away from the rear wall or the sidewall of the enclosure.

2. The vapor hood of claim 1, wherein the cable receiver extends away from the rear wall.

3. The vapor hood of claim 1, wherein the engagement surface of the cable receiver tapers toward an end that is spaced from the rear wall or sidewall of the enclosure.

4. The vapor hood of claim 1, wherein the engagement surface engages the cable with a friction fit.

5. The vapor hood of claim 1, wherein the cable receiver comprises a closed end, the closed end being cuttable or frangible to allow passage of the cable.

6. The vapor hood of claim 1, further comprising a self-supporting mounting plate attached to the skirt adjacent to the front edge, the mounting plate having an opening that aligns with the enclosure.

7. In combination:
a component of a building;
a cable connected to the component; and
a vapor hood for the component, the vapor hood comprising:
an enclosure having a sidewall, a rear wall, and a front edge opposite the rear wall, wherein the sidewall and the rear wall define an inner cavity and are sized such that the sidewall surrounds the component when installed; and
a skirt at the front edge of the enclosure that extends outward relative to the sidewall, the enclosure and the skirt being formed from waterproof, pliable material;
the enclosure comprising a cable receiver that is spaced behind the front edge, the cable receiver having an engagement surface that engages a cable when received within the cable receiver, the cable receiver extending away from the rear wall or the sidewall of the enclosure.

8. The combination of claim 7, wherein the cable receiver extends away from the rear wall.

9. The combination of claim 7, wherein the engagement surface of the cable receiver tapers toward an end that is spaced from the rear wall or sidewall of the enclosure.

10. The combination of claim 7, wherein the engagement surface engages the cable with a friction fit.

11. The combination of claim 7, wherein the cable receiver is taped against the cable.

12. The combination of claim 7, wherein the cable receiver comprises a closed end, the closed end being cuttable or frangible to allow passage of the cable.

13. The combination of claim 7, further comprising a self-supporting mounting plate attached to the skirt adjacent to the front edge, the mounting plate having an opening that aligns with the enclosure such that the front edge of the enclosure encompasses the opening.

14. A method of installing a component, the method comprising the steps of:
attaching a self-supporting mounting plate and a vapor hood to a structural member of a building, the mounting plate having an opening, the vapor hood comprising:
an enclosure having a sidewall, a rear wall, and a front edge opposite the rear wall, wherein the sidewall and the rear wall define an inner cavity and the front edge encompasses the opening of the mounting plate; and
a skirt at the front edge of the enclosure that extends outward relative to the sidewall, the enclosure and the skirt being formed from waterproof, pliable material;
the enclosure comprising a cable receiver that is spaced behind the front edge, the cable receiver, the cable receiver extending away from the rear wall or the sidewall of the enclosure;
passing a cable through the cable receiver and into the enclosure, the cable receiver having an engagement surface that engages the cable;
mounting drywall to the structural member of the building such that the drywall covers the enclosure;
cutting an opening in the drywall that leads into the enclosure of the vapor hood;
connecting the component to the cable; and
mounting the component into the opening in the drywall such that the sidewall of the vapor hood surrounds at least a portion of the component when installed.

15. The method of claim 14, wherein the mounting plate comprises a cutout guide and cutting an opening in the drywall comprises using the cutout guide to cut the opening.

16. The method of claim 14, wherein the cable receiver extends away from the rear wall.

17. The method of claim 14, wherein the engagement surface of the cable receiver tapers toward an end that is spaced from the rear wall or sidewall of the enclosure.

18. The method of claim 14, wherein the engagement surface engages the cable with a friction fit.

19. The method of claim 14, wherein passing the cable through the cable receiver further comprises the step of taping the cable receiver against the cable.

20. The method of claim 14, wherein a closed end of the cable receiver is opened to receive the cable.

21. In combination:
a self-supporting mounting plate having an opening; and
a vapor hood for a component of a building, the vapor hood comprising:
an enclosure having a sidewall, a rear wall, and a front edge opposite the rear wall, the sidewall and the rear wall defining an inner cavity, the enclosure being sized such that the sidewall surrounds the component when installed, and the front edge of the enclosure encompassing the opening of the mounting plate; and
a skirt at the front edge of the enclosure that extends outward relative to the sidewall, the enclosure and the skirt being formed from waterproof, pliable material;
the enclosure comprising a cable receiver that is spaced behind the front edge, the cable receiver having an engagement surface that engages a cable when received within the cable receiver, the cable receiver extending away from the rear wall or the sidewall of the enclosure;
wherein the skirt of the vapor hood comprises one or more apertures and the mounting plate is secured to the vapor hood by inserting at least a portion of the mounting plate through the one or more apertures.

22. The combination of claim 20, wherein the cable receiver extends away from the rear wall.

23. The combination of claim 20, wherein the engagement surface of the cable receiver tapers toward an end that is spaced from the rear wall or sidewall of the enclosure.

24. The combination of claim 20, wherein the engagement surface engages the cable with a friction fit.

25. The combination of claim 20, wherein the cable receiver is taped against the cable.

26. The combination of claim 20, wherein a closed end of the cable receiver is opened to receive the cable.

27. The combination of claim 20, wherein the mounting plate is rectangular, the skirt of the vapour hood comprises four apertures corresponding to the corners of the mounting plate, and the corners of the mounting plate are inserted through corresponding apertures.

28. The combination of claim 20, wherein the skirt and the enclosure are integrally formed from a single piece of waterproof, pliable material.
